(19) United States
(12) Patent Application Publication
(10) Pub. No.: US 2013/0033850 A1
(43) Pub. Date: Feb. 7, 2013

(54) LED Light Bar and Display Device Using the Same

(71) Applicants: Vivian Fan, Shenzhen (CN); Kuangyao Chang, Shenzhen (CN)

(72) Inventors: Vivian Fan, Shenzhen (CN); Kuangyao Chang, Shenzhen (CN)

(21) Appl. No.: 13/258,558

(22) PCT Filed: Aug. 18, 2011
(86) PCT No.: PCT/CN11/78605

§ 371 Date: Sep. 22, 2011

(30) Foreign Application Priority Data
Aug. 2, 2011 (CN) 201120277931.8

(51) Int. Cl. G09F 13/04; F21S 4/00

(52) U.S. Cl. 362/97.1; 362/225

(57) ABSTRACT

The application provides a light-emitting diode (LED) light bar and a display device using the same, wherein the LED light bar comprises a forward light string in forward series connection with the alternate current (AC), and a string in inverse series connection with the AC. The application is characterized in that the LED light bar also comprises a sharing light string. Said forward light string is in series connection with the sharing light string, and said inverse light string is in series connection with the sharing light string. The application is provided with a sharing light string which is forwardly connected into the forward light string and is inversely connected into the inverse light string. The application can use the sharing light string to act in both the forward light string and the inverse light string to save cost. Meanwhile, by improving the AC LED circuit design, the number LEDs in use is reduced; the spatial stroboflash is eliminated; the LED drive cost is reduced; and the problem of reduction of efficiency during AC-DC conversion is eliminated.

### TECHNICAL FIELD

The application relates to the field of lighting technology, and more particularly to a Light-Emitting Diode (LED) light bar and a display device using the same.

### BACKGROUND

The sustained increase of energy consumption and continued energy consumption by human society may lead to a potential depletion of energy in the near future. Thus, our society needs to use clean energy and develop more technologies for energy-saving purposes.

In the lighting technology field, LEDs gradually become higher-efficiency lighting devices because of the long service life, high light efficiency, no radiation and low power consumption. The existing LED can be driven either by a Direct Current (DC) or an Alternating Current (AC).

If a LED is driven by a DC, a converter for converting AC into DC is required. The existing LED lights driven through a converter generally have the following defects: (1) the cost is increased with the addition of a converter, and the advantage of energy-saving of LED lights is partially counteracted; (2) A converter is a passive electronic element, and its performance will degenerate with the increase of time, and its service life will be shorter than that of LEDs; thus the advantage of long service life of LEDs can not be realized because of the failure of the converter.

The disadvantage of the converter can be avoided if a LED is driven by AC. The structure of a traditional AC LED light bar is shown in FIG. 1: two strings of LED lights in series connection are used and are in inverse parallel connection; the flow directions of the currents corresponding to the positive and negative cycles of the AC are shown as the continuous lines and the dotted lines in the figure. Thus, the AC power can respectively drive the two LED light strings to emit light during the polarity conversion, to form the LED light bar for lighting.

Though the existing mode of AC drive can save the cost of converters, only one LED light string can emit light at any time. This leads to the requirement of twice the number of LED light strings under conditions of the same lighting, so the cost is increased.

### SUMMARY

For solving the problem of high cost of the AC driven LED light bar in the prior art, the application provides a LED light bar and a display device using the same, which are capable of saving the cost.

In order to achieve the above aim, an embodiment of the application provides a LED light bar, comprising a forward light string in forward series connection with the AC, an inverse light string in inverse series connection with the AC, and a sharing light string, wherein the forward light string is in forward series connection with the sharing light string, and the inverse light string is in inverse series connection with the sharing light string.

As a preference of the above technical scheme, the forward light string comprises a first forward light string M1 and a second forward light string M2, and the inverse light string comprises a first inverse light string N1 and a second inverse light string N2; the first forward light string M1 and the second forward light string M2 are in series connection with the sharing light string A, and the first inverse light string N1 and the second inverse light string N2 are in series connection with the sharing light string A.

As a preference of the above technical scheme, the sharing light string A is provided with a first end A1 and a second end A2, and all the LED lights of the sharing light string A are in forward series connection from the first end A1 to the second end A2 in order.

As a preference of the above technical scheme, the first forward light string M1, the first end A1 of the sharing light string A, the second end A2 of the sharing light string A, and the second forward light string M2 are in series connection to form the forward light string in order; and the first inverse light string N1, the second end A2 of the sharing light string A, the first end A1 of the sharing light string A, and the second inverse light string N2 are in series connection to form the inverse light string in order.

As a preference of the above technical scheme, the sum of the number of the LED lights of the first forward light string M1 and the number of the second forward light string M2 is equal to the sum of the number of the LED lights of the first inverse light string N1 and the number of the second inverse light string N2.

As a preference of the above technical scheme, the first forward light string M1, the second forward light string M2, the first inverse light string N1 and the second inverse light string N2 are respectively provided with one LED light.

As a preference of the above technical scheme, the first forward light string M1, the second forward light string M2, the first inverse light string N1 and the second inverse light string N2 are respectively provided two or more LED lights.

A display device comprises a backlight module, wherein the backlight module comprises the LED light bars.

The application provides a LED light bar and a display device using the same, wherein the LED light bar is provided with a sharing light string which is forwardly connected into the forward light string and also inversely connected into the inverse light string. Thus, the sharing light string can act simultaneously in the forward light string and the inverse light string to save cost. Meanwhile, by improving the AC LED circuit design, the number of LEDs in use is reduced; the spatial stroboflash is eliminated; the LED drive cost is reduced; and the problem of reduction of the efficiency during AC-DC conversion is eliminated. The display device using the above LED light bars reduces the number of LEDs in use, eliminates spatial stroboflash, and reduces the LED drive cost.

### BRIEF DESCRIPTION OF FIGURES

In order to more clearly describe the embodiments of this application or the technical scheme in the prior art, the figures used in the embodiments or the prior art will be simply introduced as follows. Obviously, the figures in the following description are only some embodiments of the application. For the ordinary technical personnel of the field, on the premise that no creative effort is provided, the technical personnel can also obtain other figures in accordance with these figures.

FIG. 1 is the schematic diagram of the AC LED light bar in the prior art;

FIG. 2 is the schematic diagram of the LED light string of a first embodiment of the application;

FIG. 3 is the schematic diagram of the LED light string of a second embodiment of the application.

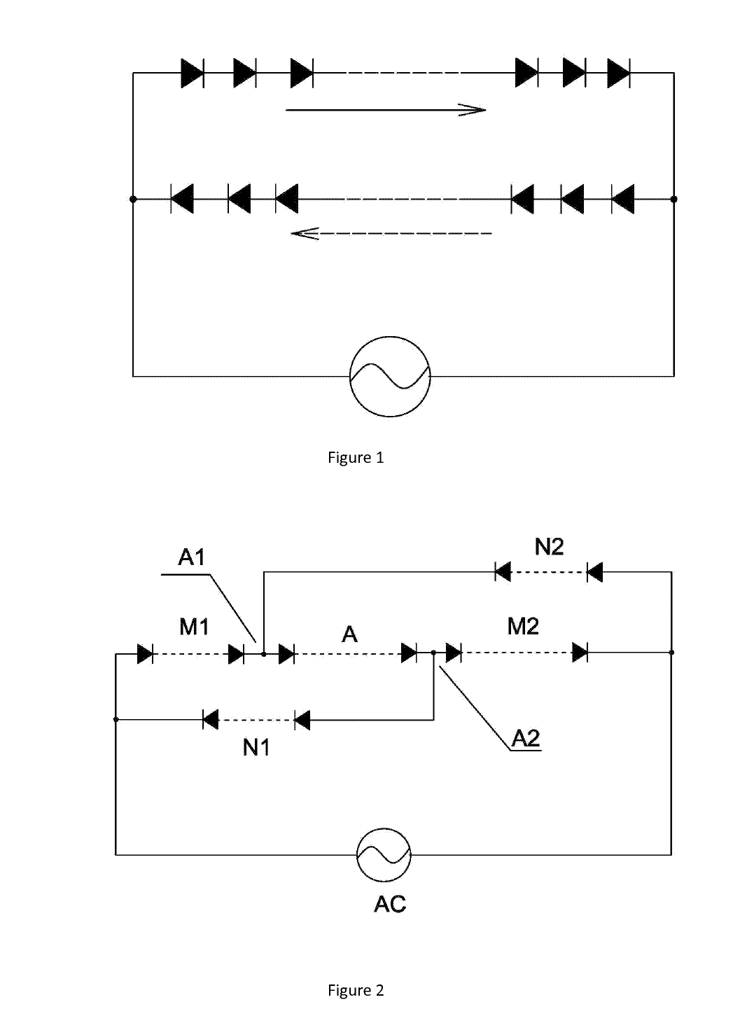

### DETAILED DESCRIPTION

The technical scheme of the application will be clearly and completely described in accordance with the figures of the application. Obviously, the described embodiments are only some of the embodiments of the application instead of all of the embodiments. On the basis of the embodiments of the application, all other embodiments, obtained by an ordinary technical personnel of the field on the premise that no creative effort is provided, should belong to the protection scope of this application.

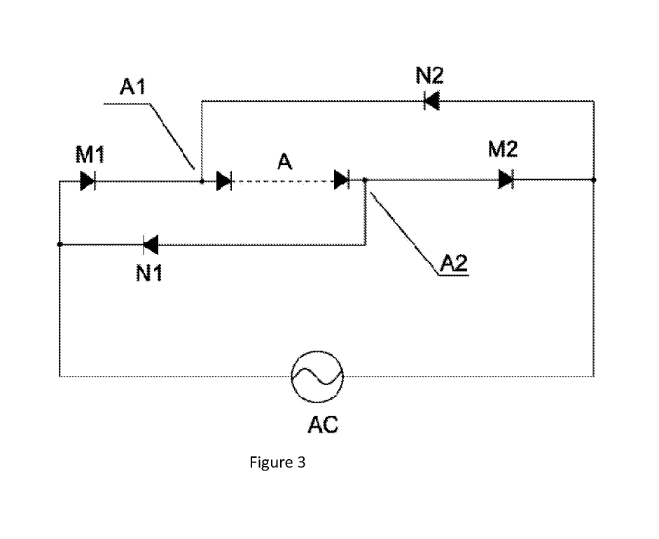

As shown in FIG. 2 and FIG. 3, the LED light bar of one embodiment of the application comprises a forward light string, an inverse light string, and a sharing light string, wherein the forward light string is in series connection with the sharing light string, and the inverse light string is in series connection with the sharing light string. Because the LED light bar of the application uses sharing light strings, the number of LED lights in use can be reduced to save cost.

Obviously, the circuit of the sharing light string can be of various connection modes, and some specific embodiments of the application will be illustrated as follows.

### Embodiment 1

A first embodiment of the application is shown in FIG. 2, wherein the forward light string comprises a first forward light string M1 and a second forward light string M2; the inverse light string comprises a first inverse light string N1 and a second inverse light string N2; the first forward light string M1 and the second forward light string M2 are in series connection with the sharing light string A, and the first inverse light string N1 and the second inverse light string N2 are in series connection with the sharing light string A.

The specific circuit diagram is shown in FIG. 2. In an embodiment, the sharing light string A is provided with a first end A1 and a second end A2, and all the LED lights of the sharing light string A are in forward series connection from the first end A1 to the second end A2 in order. In FIG. 2, the LED light bar comprises a forward light string in connection with the AC forwardly, and an inverse light string in connection with the AC inversely. As shown in FIG. 2, the first forward light string M1, the first end A1 of the sharing light string A, the second end A2 of the sharing light string A, and the second forward light string M2 are in series connection to form the forward light string in order. The first inverse light string N1, the second end A2 of the sharing light string A, the first end A1 of the sharing light string A, and the second inverse light string N2 are in series connection to form the inverse light string in order.

Thus, the sharing light string can be used both in the forward light string and the inverse light string to reduce cost. Specifically, if the connection mode of the prior art is used, (N1+N2+A)+(M1+M2+A) LED lights are required to form the LED light bar. If the technical scheme of the first embodiment of the application is used, on the premise of the same lighting condition, the sharing light string A emits light in the forward direction and the reverse direction of the AC when only (N1+N2)+(M1+M2)+A LED lights are used; therefore a LED light bar with the same luminance as that in the prior art is realized, and the cost can be reduced.

### Embodiment 2

The second embodiment of the application is shown in FIG. 3, wherein the forward light string comprises a first forward light string M1 and a second forward light string M2, and the inverse light string comprises a first inverse light string N1 and a second inverse light string N2; the first forward light string M1 and the second forward light string M2 are in series connection with the sharing light string A, and the first inverse light string N1 and the second inverse light string N2 are in series connection with the sharing light string A.

The specific circuit diagram is shown in FIG. 3. In an embodiment, the sharing light string A is provided with a first end A1 and a second end A2, and all the LED lights of the sharing light string A are in forward series connection from the first end A1 to the second end A2 in order. In FIG. 2, the LED light bar comprises a forward light string in connection with the AC forwardly, and an inverse light string in connection with the AC inversely. As shown in FIG. 2, the first forward light string M1, the first end A1 of the sharing light string A, the second end A2 of the sharing light string A, and the second forward light string M2 are in series connection to form the forward light string in order. The first inverse light string N1, the second end A2 of the sharing light string A, the first end A1 of the sharing light string A, and the second inverse light string N2 are in series connection to form the inverse light string in order. In the second embodiment, in order to save cost further, the first forward light string M1, the second forward light string M2, the first inverse light string N1 and the second inverse light string N2 are respectively provided with one light, as shown FIG. 3. From the circuit diagram shown in the FIG. 3, it is known that the design concept of the embodiment 2 is the same as that of the embodiment 1.

When M1, M2, N1 and N2 are respectively 1, an AC LED can be achieved by respectively arranging two LEDs in antiparallel direction on both sides of the LED light bar, as shown in FIG. 3. Compared with a general AC LED, this AC LED only increases the cost by two LEDs; and the position of lights is nearly unchanged though the light intensity emitted by the LED light bar varies with the AC frequency, so that the eyes of a person can only feel the temporal stroboflash.

Thus, the sharing light string can be used both in the forward light string and the inverse light string to reduce cost. Specifically, if the connection mode of the prior art is used, (1+1+A)+(1+1+A) LED lights are required to form the LED light bar. If the technical scheme of the first embodiment of the application is used, on the premise of the same lighting condition, the sharing light string A emits light in the forward direction and the reverse direction of the AC when only (1+1)+(1+1)+A LED lights are used, so that a LED light bar with the same luminous intensity as that of the prior art can be formed. Thus, the cost can be reduced.

The LED light bar can be used in a display device, wherein the display device comprises a backlight module, wherein the backlight module comprises the above LED light bar. The display device using the above LED light bar reduces the number of LEDs in use, eliminates the spacial stroboflash, and reduces the drive cost of the display device.

Embodiments shown in FIG. 2 and FIG. 3 are only some specific embodiments for illustrating the application instead of limiting the embodiments of the application. It is noted that there are various embodiments under the design concept disclosed by the application, and various specific circuits should be in the protection scope of the present invention. The aforementioned contents are only the specific embodiments of the application, and do not limit the protection scope of this invention. Any change or replacement obtained by any technical personnel of the technical field within the scope of the technology disclosed by the application should belong to the protection scope of the present invention. Therefore, the protection scope of the application should be subject to the protection scope of the Claim.

We claim:

1. A LED light bar, comprising: a forward light string which is in forward series connection with the AC, an inverse light string which is in inverse series connection with the AC, and a sharing light string; said forward light string is in forward series connection with the sharing light string; and said inverse light string is in inverse series connection with the sharing light string.

2. The LED light bar of claim 1, wherein said forward light string comprises a first forward light string (M1) and a second forward light string (M2), and said inverse light string comprises a first inverse light string (N1) and a second inverse light string (N2); said first forward light string (M1) and said second forward light string (M2) are in series connection with the sharing light string (A), and the first inverse light string (N1) and the second inverse light string (N2) are in series connection with the sharing light string (A).

3. The LED light bar of claim 1, wherein said sharing light string (A) is provided with a first end (A1) and a second end (A2), and all the LED lights of the sharing light string (A) are in forward series connection from the first end (A1) to the second end (A2) in order.

4. The LED light bar of claim 3, wherein said first forward light string (M1), the first end (A1) of the sharing light string (A), the second end (A2) of the sharing light string (A), and the second forward light string (M2) are in series connection to form the forward light string in order; and the first inverse light string (N1), the second end (A2) of the sharing light string (A), the first end (A1) of the sharing light string (A), and the second inverse light string (N2) are in series connection to form the inverse light string in order.

5. The LED light bar of claim 2, wherein the sum of the number of the LED lights of said first forward light string (M1) and the number of said second forward light string (M2) is equal to the sum of the number of LED lights of the first inverse light string (N1) and the number of the second inverse light string (N2).

6. The LED light bar of claim 2, wherein said first forward light string (M1), the second forward light string (M2), the first inverse light string (N1) and the second inverse light string (N2) are respectively provided with one LED light.

7. The LED light bar of claim 3, wherein said first forward light string (M1), said second forward light string (M2), said first inverse light string (N1) and said second inverse light string (N2) are respectively provided with one LED light.

8. The LED light bar of claim 4, wherein said first forward light string (M1), said second forward light string (M2), said first inverse light string (N1) and said second inverse light string (N2) are respectively provided with one LED light.

9. The LED light bar of claim 5, wherein said first forward light string (M1), said second forward light string (M2), said first inverse light string (N1) and said second inverse light string (N2) are respectively provided with one LED light.

10. The LED light bar of claim 2, wherein said first forward light string (M1), said second forward light string (M2), said first inverse light string (N1) and said second inverse light string (N2) are respectively provided with two or more LED lights.

11. The LED light bar of claim 3, wherein said first forward light string (M1), said second forward light string (M2), said first inverse light string (N1) and said second inverse light string (N2) are respectively provided with two or more LED lights.

12. The LED light bar of claim 4, wherein said first forward light string (M1), said second forward light string (M2), said first inverse light string (N1) and said second inverse light string (N2) are respectively provided with two or more LED lights.

13. The LED light bar of claim 5, wherein said first forward light string (M1), said second forward light string (M2), said first inverse light string (N1) and said second inverse light string (N2) are respectively provided with two or more LED lights.

14. A display device, comprising: a backlight module, said backlight module comprises said LED light bar of claim 2.

15. The display device of claim 14, wherein said the sharing light string (A) is provided with a first end (A1) and a second end (A2), and all the LED lights of the sharing light string (A) are in forward series connection from the first end (A1) to the second end (A2) in order.

16. The display device of claim 15, wherein said first forward light string (M1), the first end (A1) of the sharing light string (A), the second end (A2) of the sharing light string (A) and the second forward light string (M2) are in series connection to form the forward light string in order; and the first inverse light string (N1), the second end (A2) of the sharing light string (A), the first end (A1) of the sharing light string (A), and the second inverse light string (N2) are in series connection to form the inverse light string in order.

17. The display device of claim 14, wherein the sum of the number of the LED lights of said first forward light string (M1) and the number of said second forward light string (M2) is equal to the sum of the number of the LED lights of the first inverse light string (N1) and the number of the second inverse light string (N2).
